(19) United States
(12) Patent Application Publication
(10) Pub. No.: US 2012/0139359 A1
(43) Pub. Date: Jun. 7, 2012

(54) WIRELESS CHARGING SYSTEM AND TRANSMITTING END CIRCUIT THEREOF

(76) Inventors: Ming-Iu LAI, Taipei (TW); Chun-Hsiung WANG, Taipei (TW)

(21) Appl. No.: 13/312,731

(22) Filed: Dec. 6, 2011

Related U.S. Application Data
(60) Provisional application No. 61/420,128, filed on Dec. 6, 2010.

(51) Int. Cl. H01F 38/14; H02M 7/00

(52) U.S. Cl. 307/104; 363/123

(57) ABSTRACT

A transmitting end circuit includes a rectifying unit, a control unit, a resonant unit, a primary coil and an inductor unit. The control unit outputs a control signal to the rectifying unit. The resonant unit has a first end connected to the rectifying unit. The primary coil is connected to the resonant unit. The inductor unit is connected to a second end of the primary coil and the controlling unit.

### CROSS REFERENCE TO RELATED APPLICATIONS

The non-provisional patent application claims priority to U.S. provisional patent application with Ser. No. 61/420,128 filed on Dec. 6, 2010. This and all other extrinsic materials discussed herein are incorporated by reference in their entirety.

### BACKGROUND OF THE INVENTION

1. Field of Invention

The invention relates to a wireless charging system and, more particularly, to a wireless charging system and a transmitting end circuit thereof.

2. Related Art

Wireless charging systems using electromagnetic induction technology are greatly developed and widely used in various electronic devices, such as an electrical toothbrush and a mobile phone. In charging process, a transmitting end circuit of the wireless charging system provides power, and a receiving end circuit of the wireless charging system charges via electromagnetic induction.

A conventional electromagnetic charging system uses an independent transmitting chip and a receiving chip, and thus the cost is high. Furthermore, in the wireless charging system, the transmitting end circuit needs to determine whether a load (that is the receiving end circuit) is well disposed in order to do the charging. In practical usage, the effect of the load needs to be eliminated by using some special methods and circuits, and then whether the load is disposed can be determined more accurately, which brings a high cost and needs a complicate circuit.

### SUMMARY OF THE INVENTION

A transmitting end circuit disclosed herein includes a rectifying unit, a control unit, a resonant unit, a primary coil and an inductor unit. The control unit outputs a control signal to the rectifying unit. The resonant unit includes a first end connected to the rectifying unit. The primary coil is connected to the resonant unit. The inductor unit is connected to a second end of the primary coil and the control unit.

A wireless charging system is also disclosed here. The system includes a transmitting end circuit and a receiving end circuit. The transmitting end circuit includes a rectifying unit, a control unit, a resonant unit, a primary coil and an inductor unit. The control unit outputs a control signal to the rectifying unit. The resonant unit includes a first end connected to the rectifying unit. The primary coil is connected to the resonant unit. The inductor unit is connected to a second end of the primary coil and the control unit. The receiving end circuit includes a secondary coil.

These and other features, aspects and advantages of the present invention will become better understood with regard to the following description, appended claims, and accompanying drawings.

### BRIEF DESCRIPTION OF THE DRAWINGS

FIG. 1 is a block diagram showing a wireless charging system in an embodiment;

FIG. 2 is a schematic diagram showing the circuit of a transmitting end circuit in FIG. 1;

FIG. 3 is a schematic diagram showing waveforms at a first end of a resonant unit and at a second end of a primary coil in FIG. 2 with a load and without a load; and

FIG. 4 is another schematic diagram showing waveforms at the first end and the second end with a load and without a load in another embodiment.

### DETAILED DESCRIPTION OF THE INVENTION

A wireless charging system and a transmitting end circuit thereof are illustrated with relating figures, and the same symbols denote the same components.

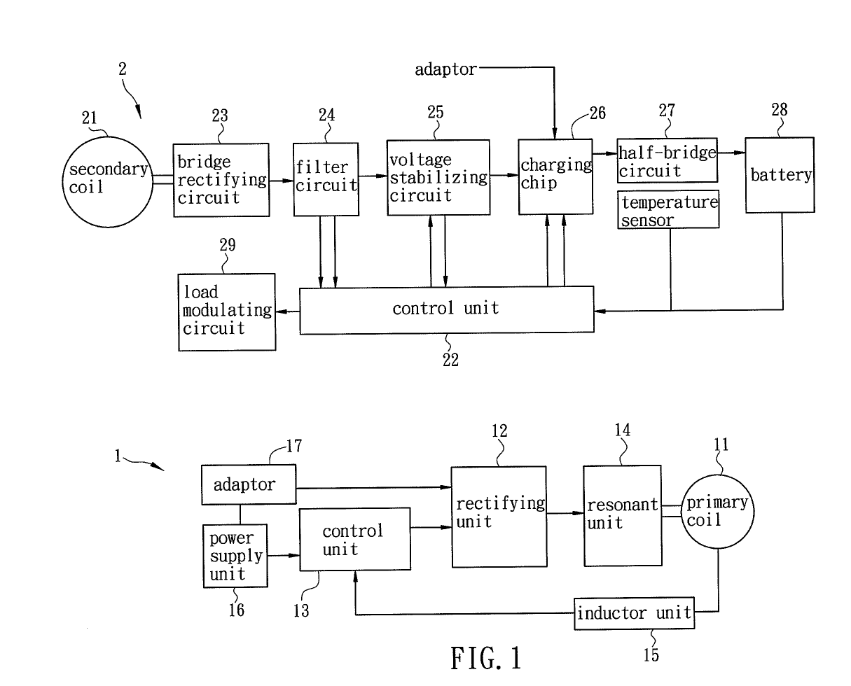

FIG. 1 is a block diagram showing a wireless charging system in an embodiment. The wireless charging system includes a transmitting end circuit 1 and a receiving end circuit 2. The transmitting end circuit 1 includes a primary coil 11, and the receiving end circuit 2 includes a secondary coil 21. When the receiving end circuit 2 approaches the transmitting end circuit 1 in a preset distance, the transmitting end circuit 1 provides power to the primary coil, and the primary coil 11 interacts with the secondary coil 21 to produce induction. Consequently, the receiving end circuit 2 is charged via the electromagnetic induction between the secondary coil 21 and the primary coil 11.

The transmitting end circuit 1 further includes a rectifying unit 12, a control unit 13, a resonant unit 14 and an inductor unit 15. The rectifying unit 12 may include a half-bridge circuit. The control unit 13 outputs a control signal to the rectifying unit 12. The control unit 13 may include a micro control unit (MCU). The MCU may be integrated with periphery circuits to reduce the cost. A first end of the resonant unit 14 is connected to the rectifying unit 12. The resonant unit 14 may include a capacitor.

Moreover, the primary coil 11 is connected to the resonant unit 14. A second end of the primary coil 11 is connected to the inductor unit 15. The inductor unit 15 is further connected to the control unit 13. The inductor unit 15 may include an inductor or an equivalent circuit including an inductor and other circuits. The electrical connection stated above may be a direct electrical connection or an indirect electrical connection. The term “indirect electrical connection” refers to a connection via other circuits or components. Furthermore, components of the circuit unit stated above are just examples, and they can be replaced by other equivalent circuits.

The transmitting end circuit 1 further includes a power supply unit 16 and an adaptor 17. The power supply unit 16 is electrically connected to the adaptor 17 and the control unit 13, respectively. The power supply unit 16 can get power from an external power source and provides power to the control unit 13. The adaptor 17 is electrically connected to the power supply unit 16 and the rectifying unit 12, respectively, and it transforms voltage to provide power to the rectifying unit 12.

The receiving end circuit 2 may further include a control unit 22, a bridge rectifying circuit 23, a filter circuit 24, a voltage stabilizing circuit 25, a charging chip 26, a half-bridge circuit 27, a battery 28, a temperature sensor and a load modulating circuit 29. The electrical connection between the components stated above can refer to FIG. 1, which is omitted herein. The control unit 22 includes a MCU. Consequently, the control unit 22 can be integrated with peripheral circuits via the MCU to reduce the cost.

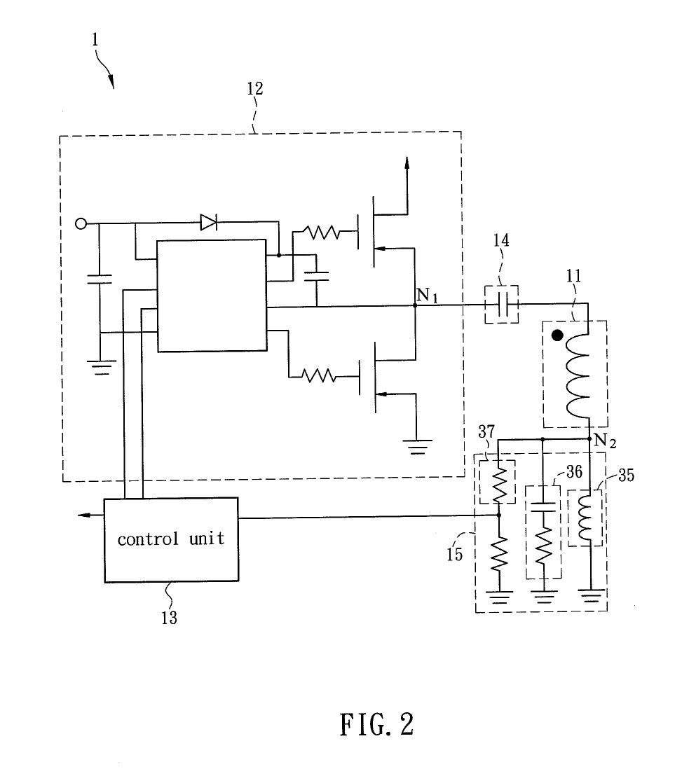

FIG. 2 is a schematic diagram showing the circuit of the transmitting end circuit in FIG. 1. The adaptor 17 and the power supply unit 16 of the transmitting end circuit 1 are not shown in the figure, and only the primary coil 11, the rectifying unit 12, the control unit 13, the resonant unit 14 and the inductor unit 15 of the transmitting end circuit 1 are shown. The rectifying unit 12 includes a half-bridge circuit. The control unit 13 may include a MCU and outputs a control signal to the rectifying unit 12. The control signal may be a pulse width modulation (PWM) signal. The resonant unit 14 is a capacitor, and the first end N₁ of the resonant unit 14 is connected to the rectifying unit 12. The primary coil 11 is electrically connected to the resonant unit 14, and a second end N₂ of the primary coil 11 is connected to the inductor unit 15. The inductor unit 15 may be an inductor 35, and the inductance value may be 1 μH or smaller.

Moreover, the inductor unit 15 further includes a filter unit 36. The filter unit 36 is connected in parallel to the inductor 35 and filters out noise in high frequency. The filter unit 36 may include a resistor and a capacitor. The inductor unit 15 further includes a measuring unit 37 connected to the second end N₂ of the primary coil 11 and the control unit 13 to measure the voltage at the second end N₂ in a manner of a divider resistor.

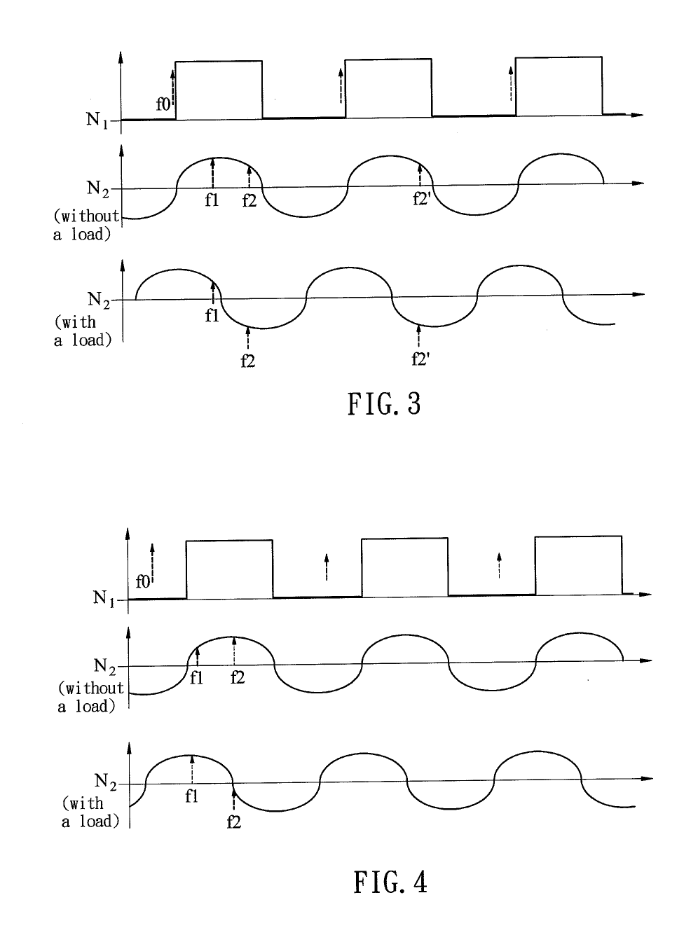

FIG. 3 is a schematic diagram showing waveforms at the first end N₁ of the resonant unit 14 and at the second end N₂ of the primary coil 11 in FIG. 2 with a load and without a load. As shown in FIG. 1, the receiving end circuit 2 includes a load including multiple components. When the receiving end circuit 2 does not approach the primary coil 11 of the transmitting end circuit 1 in a preset distance, for the primary coil 11, a load does not exist. The first end N₁ and the second end N₂ show inductive character, and waveforms at the two ends have the same phase. As shown in FIG. 3, the square waveform of the first end N₁ and the cosine waveform of the second end N₂ have the same phase.

However, when the receiving end circuit 2 approaches the primary coil 11 of the transmitting end circuit 1 in the preset distance, for the primary coil 11, the receiving end circuit 2 is the load, and thus the first end N₁ shows resistive character. The second end N₂ still shows inductive character, and the waveforms at the two ends have a phase difference of about 90 degrees, as shown in the square waveform at the first end N₁ and the sinusoidal waveform at the second end N₂ in FIG. 3. The waveforms at the first end N₁ and the second end N₂ are sent to the control unit 13. Consequently, the control unit 13 can determine whether a load exists, that is, whether the receiving end circuit 2 approaches in the preset distance, according to the phases, and then the transmitting end circuit 1 provides power in a wireless way, so as to control whether to provide power precisely.

The mechanism of determining the same phase or the phase difference of 90 degrees may be achieved by measuring the voltage of the second end N₂ at two different time points. For example, in FIG. 3, the time point f0 is at a rising edge of the square waveform, the time point f1 is set at the time point less than one quarter of the period (¼T), and the time point f2 is set at the time point between the time point f1 and half of the period (that is, f1+¼T, between one quarter of the period and half of the period). If the voltages at the time point f1 and the time point f2 have opposite phases (as shown in the bottom wave in FIG. 3), it means a load exists, and the receiving end circuit 2 approaches to be charged. If the voltages at the time point f1 and the time point f2 have the same phase (as shown in the middle figure in FIG. 3), it means no load, the receiving end circuit 2 does not approach in the preset distance, and the transmitting end circuit 1 does not charge. In FIG. 2, a divider resistor is used as the measuring unit 37 to measure the voltages of the second end N₂ at the time point f1 and the time point f2.

As shown in FIG. 3, when it is detected that the voltage at the first end N₁ changes from low potential to high potential (ID), after a short processing time, the control unit 13 enables an analog-digital converter (ADC) at the time point f1 to read the first voltage of the second end N₂, and then reads the second voltage of the second end N₂ at the time point f2. If the voltages at the time point f1 and the time point f2 have the opposite phases, it means that a load exists. Since the time interval between the time point f1 and the time point f2 is short (such as 1 g to 2 g second), if the converting speed (such as a hundred KHz) of the ADC is not quick enough, the voltage of the second end N₂ at the time point f2 is read in the next period, such as at the time point f2′ in FIG. 3.

The positions of the time point f0, the time point f1 and the time point f2 in the above embodiment are just an example, and they also may be at other positions. FIG. 4 is another schematic diagram showing waveforms at the first end and the second end, that is, the positions of the time point f0, the time point f1 and the time point f2 in FIG. 3 are changed. Comparing with FIG. 3, the time point ID is a little ahead, and thus when the load exists, the voltage at the time point f1 is close to the maximum voltage of the second end N₂. The voltage at the time point f1 can be converted to amplitude of alternating current of the primary coil. If the current is larger than a preset value, the control signal would not be outputted to avoid circuit damage. The control unit 13 is used to stop outputting the control signal according to comparison of the voltage at the time point f1 and the preset value. In the embodiment, the control unit 13 compares the current converted from the voltage at the time point f1 and the preset value to determine whether to stop outputting the control signal.

In sum, a first end of a resonant unit of a transmitting end circuit is connected to a rectifying unit. An inductor unit is connected to a second end of a primary coil. Without a load, the first end of the resonant unit is inductive, the second end of the primary coil is inductive, and waveforms of the first end and the second end have the same phase. With a load, the first end is the resistive, the second end is inductive, and the waveforms of the first end and the second end have a phase difference of 90 degrees. Consequently, it can be determined whether a load exists according to the phases of waveforms of the first end and the second end.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A transmitting end circuit, comprising:
a rectifying unit;
a control unit outputting a control signal to the rectifying unit;
a resonant unit including a first end connected to the rectifying unit;
a primary coil connected to the resonant unit; and
an inductor unit connected to a second end of the primary coil and the control unit.

2. The transmitting end circuit according to claim 1, wherein when a receiving end circuit approaches the transmitting end circuit in a preset distance, a phase difference is between the first end and the second end.

3. The transmitting end circuit according to claim 1, wherein when a receiving end circuit does not approach the transmitting end circuit in a preset distance, the first end and the second end have the same phase.

4. The transmitting end circuit according to claim 1, wherein the inductor unit includes an inductor.

5. The transmitting end circuit according to claim 4, wherein the inductor unit further includes:
a filter unit connected to the second end of the primary coil and the inductor unit.

6. The transmitting end circuit according to claim 5, wherein the filter unit includes
a resistor connected in series with a capacitor.

7. The transmitting end circuit according to claim 4, wherein the inductor unit further includes:
a measuring unit connected to the second end of the primary coil and the control unit, measuring a first voltage value of the second end at a first time point, and measuring a second voltage value of the second end at the second time point.

8. The transmitting end circuit according to claim 7, wherein when a receiving end circuit approaches the transmitting end circuit in the preset distance, the first voltage and the second voltage have opposite voltage phases.

9. The transmitting end circuit according to claim 7, wherein when a receiving end circuit does not approach the transmitting end circuit in a preset distance, the first voltage and the second voltage have the same voltage phase.

10. The transmitting end circuit according to claim 7, wherein the control unit has a preset value, when the first voltage or the second voltage is larger than the preset value, the control unit stops outputting the control signal.

11. A wireless charging system, comprising:
a transmitting end circuit, including:
a rectifying unit;
a control unit outputting a control signal to the rectifying unit;
a resonant unit including a first end connected to the rectifying unit;
a primary coil connected to the resonant unit; and
an inductor unit connected to a second end of the primary coil and the control unit; and
a receiving end circuit including a secondary coil.

12. The wireless charging system according to claim 11, wherein when the receiving end circuit approaches the transmitting end circuit in a preset distance, the primary coil interacts with the secondary coil, and a phase difference is between the first end and the second end.

13. The wireless charging system according to claim 11, wherein when the receiving end circuit does not approach the transmitting end circuit in a preset distance, the first end and the second end have the same phase.

14. The wireless charging system according to claim 11, wherein the inductor unit includes an inductor.

15. The wireless charging system according to claim 14, wherein the inductor unit further includes:
a filter unit connected to the second end of the primary coil and connected in parallel to the inductor unit.

16. The wireless charging system according to claim 15, wherein the filter unit includes a resistor connected in series with a capacitor.

17. The wireless charging system according to claim 14, wherein the inductor unit further includes:
a measuring unit connected to the second end of the primary coil and the control unit, measuring a first voltage of the second end at a first time point, and measuring a second voltage of the second end at a second time point.

18. The wireless charging system according to claim 17, wherein when the receiving end circuit approaches the transmitting end circuit in a preset distance, the first voltage and the second voltage have opposite voltage phases.

19. The wireless charging system according to claim 17, wherein when the receiving end circuit does not approach the transmitting end circuit in a preset distance, the first voltage and the second voltage have the same voltage phase.

20. The wireless charging system according to claim 17, wherein the control unit has a preset value, when the first voltage or the second voltage is larger than the present value, the control unit stops outputting the control signal.
